(19) United States
(12) Patent Application Publication
(10) Pub. No.: US 2016/0223273 A1
(43) Pub. Date: Aug. 4, 2016

(54) Heat Exchanger with Improved Configuration

(71) Applicant: LEVEL HOLDING B.V., Son (NL)

(72) Inventor: Wessel Bart Veltkamp, Son (NL)

(21) Appl. No.: 15/022,365

(22) PCT Filed: Sep. 10, 2014
(86) PCT No.: PCT/NL2014/050618

§ 371 Date: Mar. 16, 2016

(30) Foreign Application Priority Data
Sep. 17, 2013 (NL) 2011454

(51) Int. Cl. F28F 13/02; F28F 3/08; B29C 51/10; B29C 51/08; B29C 51/14; F28D 9/00; F28F 21/06

(52) U.S. Cl. CPC F28F 13/02; F28D 9/0037; F28F 3/08; F28F 21/065; B29C 51/082; B29C 51/14; B29C 51/10; B29K 2105/256

(57) ABSTRACT

The invention relates to a heat exchanger provided with a number of sheets (4) stacked onto each other and extending parallel, wherein all sheets (4) are provided with profiles which form ducts (8) extending between the sheets (4) and wherein the ducts (8) present on either side of a sheet (4) extend parallel, wherein each of the sheets (4) lies adjacent on one of its sides to ducts (8) of the first type and lies adjacent on its other side to ducts (8) of the second type, wherein adjoining sheets (4) stacked onto each other are mutually connected at their edges extending parallel to the ducts (8), wherein the sheets (4) are stacked with the lower wall of the ducts (8) of an upper-lying sheet (4) above the upper wall of the ducts (8) of the underlying sheet (4).

The invention relates to a heat exchanger comprising a number of sheets stacked onto each other and extending mutually parallel, wherein at least some of the number of sheets are provided over at least a part of their surface with profiles which form ducts extending between the sheets and the ducts present on either side of a sheet extend parallel, wherein each of the sheets lies adjacent on one of its sides to ducts of the first type and lies adjacent on its other side to ducts of the second type, and wherein adjoining sheets stacked onto each other are mutually connected at their edges extending parallel to the ducts.

Such a heat exchanger is known from the European patent application EP-A-0 666 973. This prior art heat exchanger is provided with ducts of substantially triangular section. The flow resistance in the ducts of this heat exchanger is therefore considerable. This requires a relatively large amount of power from an air pump or a fan for the purpose of maintaining the required flow, thereby decreasing the total efficiency of the device of which the heat exchanger forms part. It seems attractive to extend two walls of the triangular ducts in order to enlarge the passage of the ducts without reducing the heat transfer. This results in a duct with a cross-section with an acute angle. Calculations have shown that the flow in the vicinity of the acute angle is negligible, so that with this modification the flow resistance decreases only a little relative to the prior art configuration.

WO-A-2013093375 further shows a heat exchanger comprising a number of sheets stacked onto each other and extending mutually parallel, wherein at least some of the number of sheets are provided over at least a part of their surface with profiles which form ducts extending between the sheets and wherein the ducts present on either side of a sheet extend parallel, wherein each of the sheets lies adjacent on one of its sides to ducts of the first type and lies adjacent on its other side to ducts of the second type, wherein adjoining sheets stacked onto each other are mutually connected at their edges extending parallel to the ducts, wherein all sheets are provided with a profile and the profile of each sheet extends over the whole surface of the heat exchanger, and wherein the average height of the ducts is greater than their average width. As a result of the greater height of the ducts the flow resistance is much lower than in the initially stated

The invention has for its object to provide such a heat exchanger wherein the flow resistance is even lower.

This is achieved by a heat exchanger of the above stated type, wherein the sheets are stacked with the lower wall of the ducts of an upper-lying sheet above the upper wall of the ducts of the underlying sheet.

It is noted here that the terms ‘lower wall’ and ‘upper wall’ relate to the situation in which the main plane of the sheets extends horizontally.

As a result of this measure a duct is obtained with an even greater height than in WO-A-2013093375, so that an even better distribution of the airflow is obtained and the flow resistance is reduced. It is noted here that—with an extreme height of the ducts of this prior art—it is possible to achieve the same height, though at the expense of the structural strength of the heat exchanger. The proposal according to the invention does not have this drawback.

The profile arranged in the sheets and forming the ducts preferably has the form of multiple trapeziums. Research has shown that this form of duct results in an optimal flow distribution.

The above described form makes the sheet difficult to remove from the mould after thermoforming, since the form of the mould and the formed sheet is not always releasing. In order to facilitate removal of the sheet, the ducts have a fold on at least one of their walls extending parallel to the main plane of the sheet. The fold makes deformation of the formed sheet easier by folding together of the parts of the sheet located adjacently of the fold, so that these sheets can be removed from the mould more easily.

According to a further embodiment the ducts have a fold on both their walls extending parallel to the main plane of the sheet. The second fold is not essential for release from the mould, although this fold in the second surface makes stacking of the sheets easier since this second fold fits into the first fold of the underlying sheet. This also increases the stability of the heat exchanger formed during the stacking. It is noted here that in order to achieve this effect it is essential that the folds are arranged in the same direction.

Substantially trapezium-shaped ducts can be embodied in two different configurations, i.e. with obtuse angles between the walls and with acute angles between the walls. If the configuration with obtuse angles is chosen, the walls extending parallel to the main plane are narrow between the inclining walls, while in the configuration with acute angles the walls extending parallel to the main plane are wide. Although the configuration with the obtuse angles is more attractive from the viewpoint of material use, it is nevertheless recommended to apply the configuration with the acute angles since the stackability of this latter configuration is better. According to a preferred embodiment, the angles between the walls of the ducts forming part of a single sheet are acute.

Tests have shown that the optimal flow resistance is obtained when the assembled ducts which are enclosed by two connecting sheets have a constriction in their centre, and the constriction of the ducts is smaller than 20% of the maximum width of the duct.

According to a further embodiment, the sheets extend on a first and a second side, lying opposite the first side, of the heat exchanger to a position outside the heat exchanger, the parts of the sheets extending on respectively the first and second side of the heat exchanger form respectively a first and second coupling piece, the first coupling piece is configured to couple a first external duct to a first end of the ducts of the first type and to couple a second external duct to the first end of the ducts of the second type, and the second coupling piece is configured to couple a third external duct to the second end of the ducts of the first type and to couple a fourth external duct to the second end of the ducts of the second type. As in the prior art heat exchanger, use is hereby made of the fact that ducts of different types lie are located either side of each of the sheets. The sheets thus serve as separation between the ducts of the different types which can be continued into the coupling piece.

According to a further preferred embodiment, the sheets are formed from thermally deformable plastic sheets by means of a thermoforming process.

The same embodiment provides a method for manufacturing a heat exchanger, comprising of arranging a profile in plastic sheets by means of a thermoforming process, stacking the sheets and mutually connecting the stacked sheets at least at their edges, wherein the sheets are stacked onto each other without interposing flat sheets. Stacking hereby becomes simpler. The lower or the upper sheet of the stack is however flat in many cases.

The sheets are preferably stacked with the lower wall of the ducts of an upper-lying sheet above the upper wall of the ducts of the underlying sheet.

As already stated, the combination of the sheet provided between the walls by thermoforming a trapezium-shaped profile with acute angles and the mould in which the sheet is formed is not self-releasing. Since the repeating profile makes it impossible to divide the mould, an embodiment of the invention proposes that the sheet parts which after the thermoforming are enclosed due to form-locking in a mould used in the thermoforming process are deformed during removal of the sheets from these moulds.

In order to facilitate the deformation it is recommended that the sheet parts enclosed in the mould by form-locking are deformed by blowing in air from openings arranged in the mould.

In prior art thermoforming processes use is made of a pressure difference on either side of the sheet for deforming, so that the sheet deforms and is urged against the mould.

Since in the application according to the invention the dimensions of the profiles transversely of the main direction of the sheet are rather large relative to the width of the profiles, deforming of the sheet is facilitated in that the sheets are formed during the thermoforming process by a counter-mould provided with protrusions which, in the position in which the sheets have reached their final form, extend into cavities arranged in the mould.

In order to further facilitate the deforming it is recommended that air is blown in during the thermoforming process from openings arranged in the counter-mould.

This embodiment also relates to a device for manufacturing sheets for a heat exchanger by means of a thermoforming process, wherein the device is provided with a mould, the profile of which corresponds to the profile to be arranged in the sheets, means for respectively heating and cooling the sheets, supply and discharge means for respectively supplying and discharging the sheets to and from the mould, and air pressure means for temporarily applying to the side of the sheet facing away from the mould an air pressure which is higher than the air pressure prevailing on the side of the sheet facing toward the mould, wherein the device comprises a counter-mould provided with protrusions which extend during the thermoforming process into cavities arranged in the mould.

It is recommended that, in the mould in the position of the counter-mould lying closest to the mould, the protrusions of the counter-mould extend into the deepest point of the cavities. After all, the position of the walls of the trapezium-shaped duct is hereby defined as well as possible.

Since it is likewise important to properly define the parts of the sheet which cannot be deformed or hardly so, it is attractive that, in the position of the counter-mould lying closest to the mould, the mould and the counter-mould enclose the sheet outside the cavities of the mould.

In order to further facilitate release, a further preferred embodiment proposes that the air pressure means are configured to temporarily apply to the side of the sheet facing away from the mould an air pressure which is lower than the air pressure prevailing on the side of the sheet facing toward the mould.

A structurally attractive embodiment is created when the air pressure means are provided with air ducts ending in the cavities of the mould and connected to an air pump, and with air ducts ending in the cavities of the counter-mould and connected to an air pump.

In order to enable the deformation necessary for releasing the deformed sheet from the mould it is important that, in the position of the counter-mould lying closest to the mould, space is present laterally of the protrusions of the counter-mould between these protrusions and the cavities of the mould.

The present invention will now be elucidated with reference to the accompanying figures, in which:

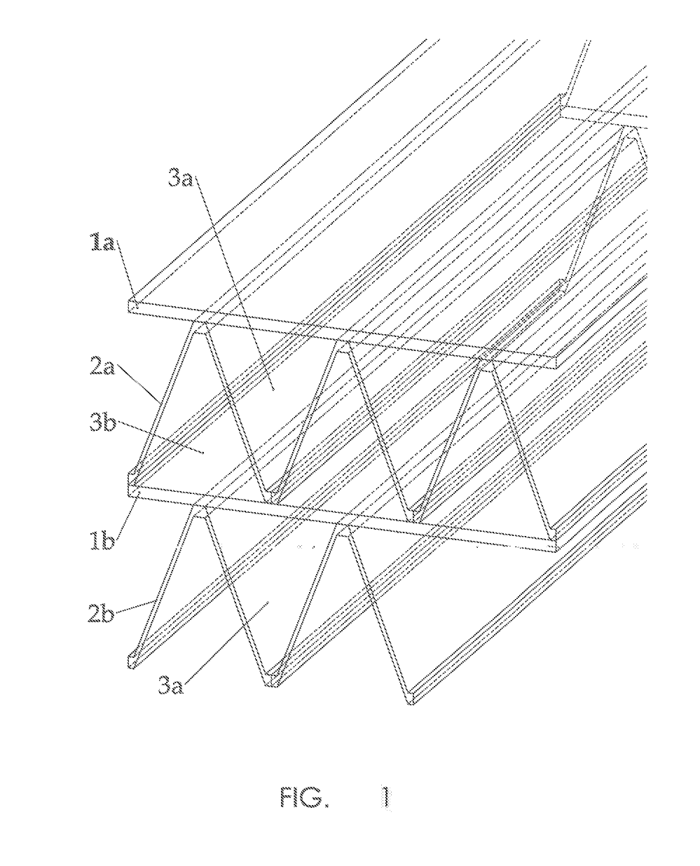

FIG. 1 is a schematic perspective view of a prior art heat exchanger;

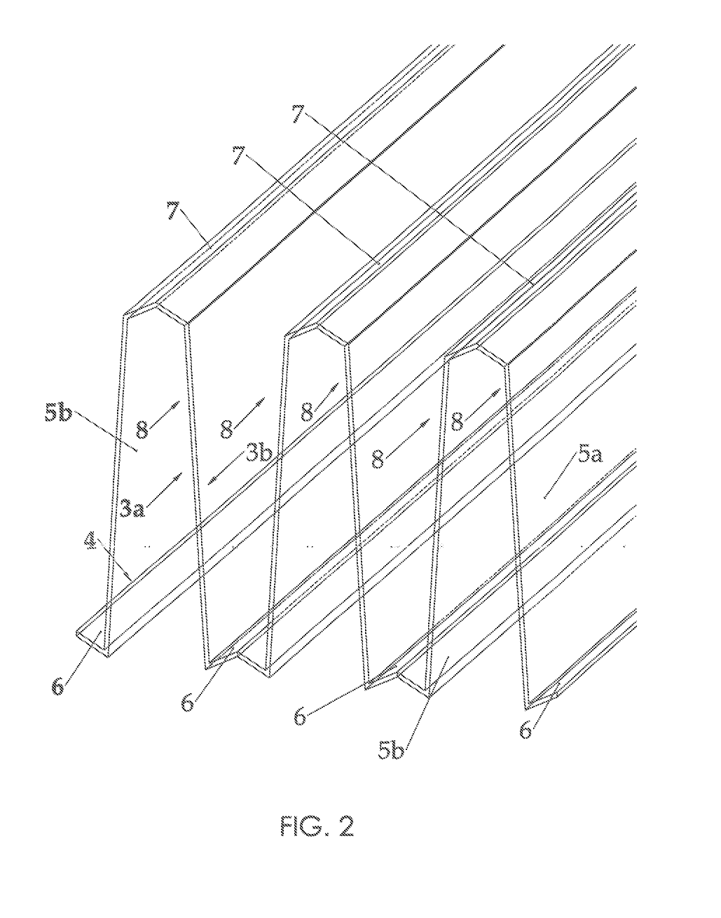

FIG. 2 is schematic perspective view of a sheet for a heat exchanger for use in a heat exchanger according to the invention;

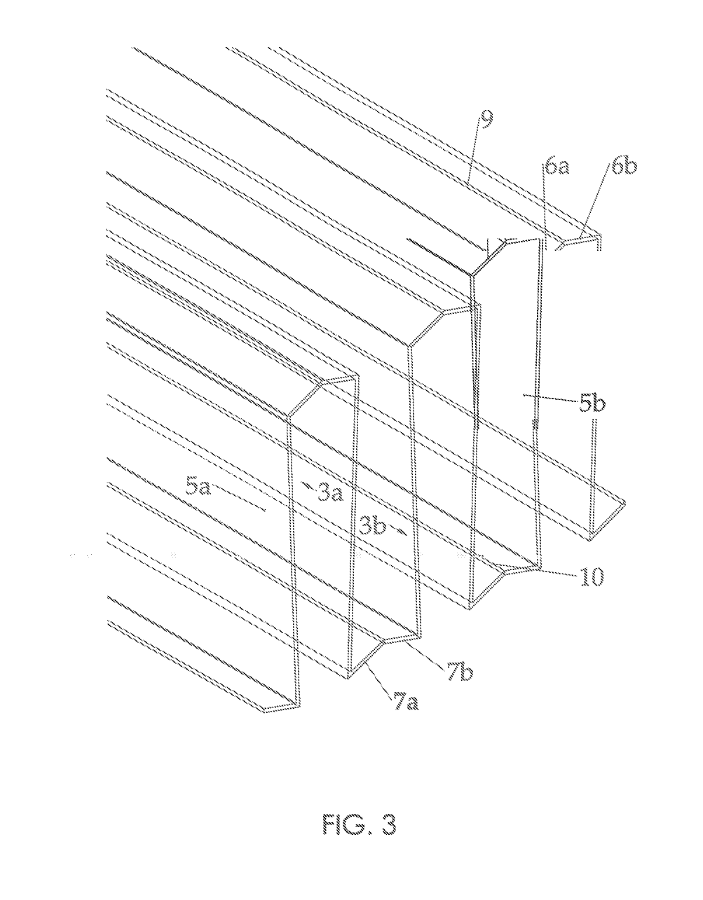

FIG. 3 is a schematic perspective view of a sheet for a heat exchanger according to a first embodiment of the invention;

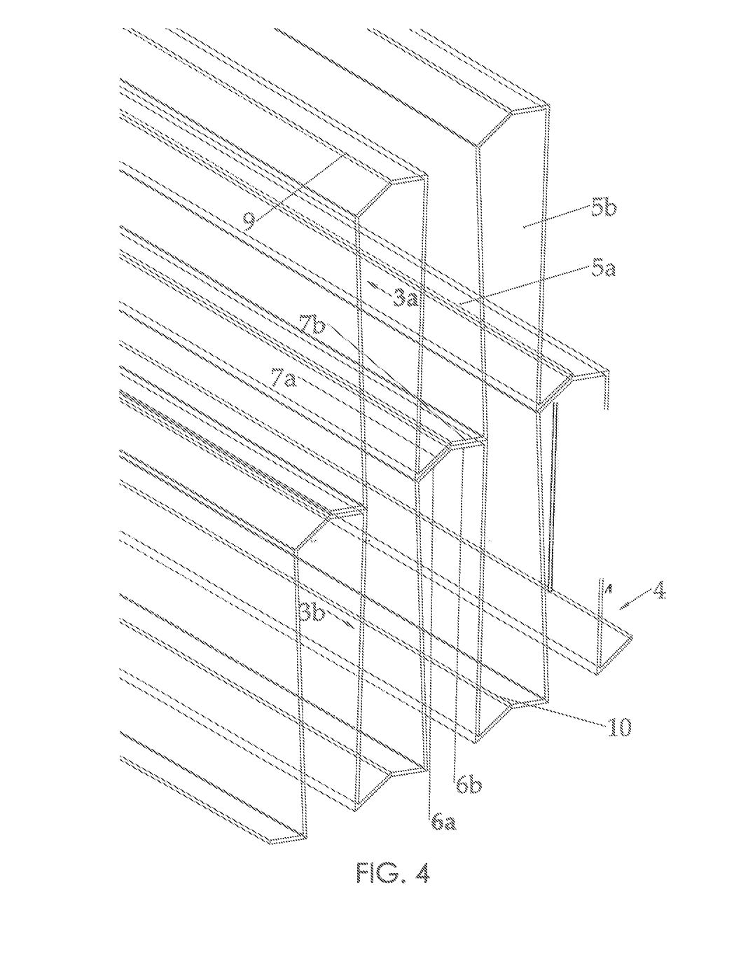

FIG. 4 is a schematic perspective view of a heat exchanger according to the first embodiment;

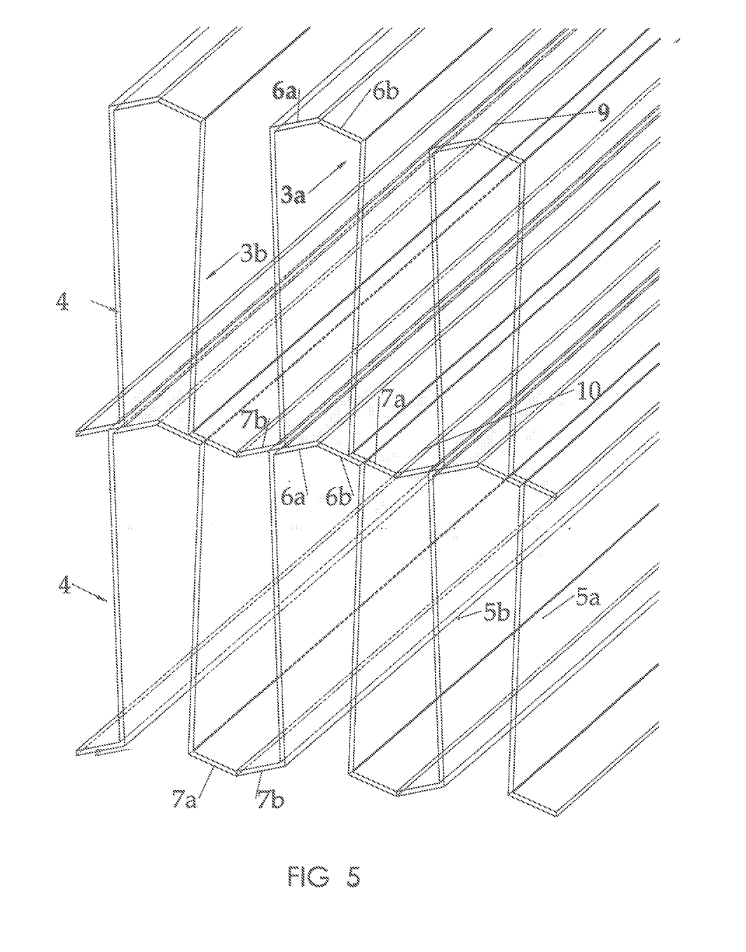

FIG. 5 is a schematic perspective view of a heat exchanger according to the second embodiment;

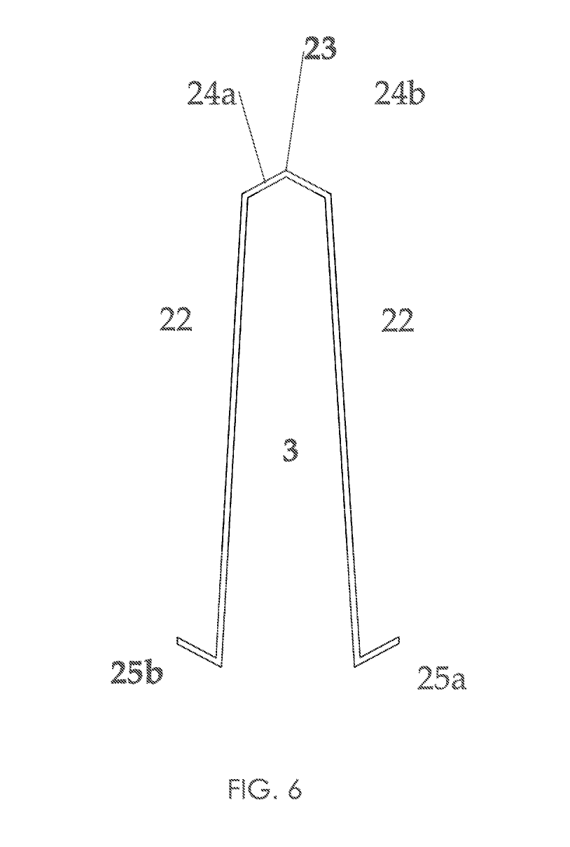

FIG. 6 is a cross-sectional view of a part of a sheet for a heat exchanger for use in a heat exchanger according to the invention;

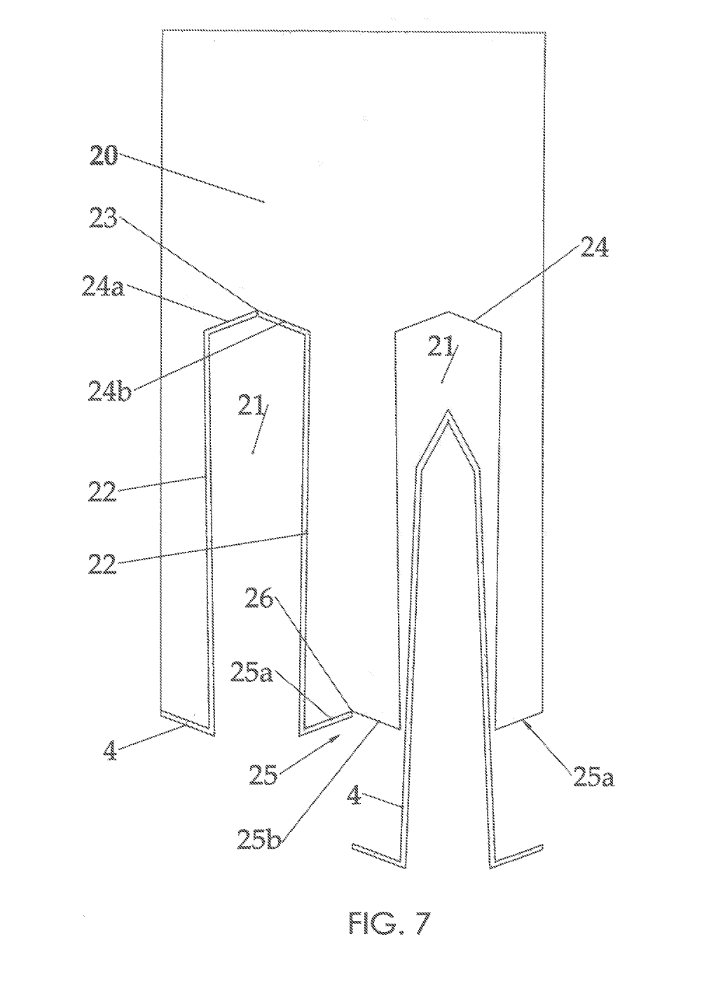

FIG. 7 is a view corresponding to FIG. 6 at different stages of manufacture;

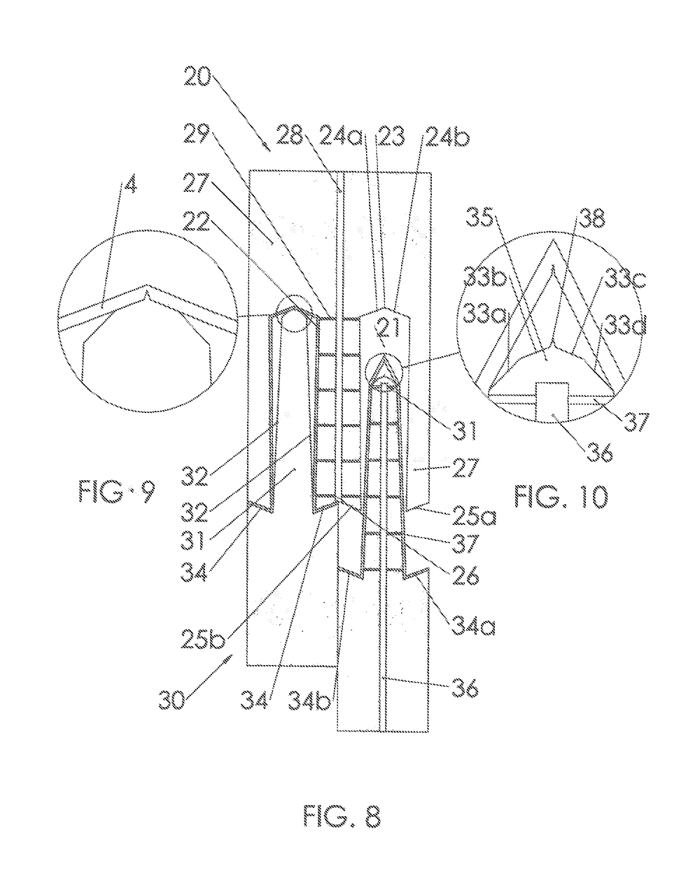

FIG. 8 is a cross-sectional view of a combination of a mould and a counter-mould according to the invention;

FIG. 9 is a first detail view of FIG. 8; and

FIG. 10 is a second detail view of FIG. 8.

The prior art heat exchanger shown in FIG. 1 comprises a number of flat mutually parallel sheets, of which FIG. 1 shows two sheets 1a, 1b. Arranged between each of the two flat sheets 1 are sheets 2 formed in a triangular profile, two of which 2a, 2b are shown in FIG. 1. Ducts 3 with a substantially triangular section are formed between flat sheets 1 and the sheets 2 provided with a profile. The upper flat sheet 1a and the upper sheet 2a provided with a profile here enclose ducts 3a of the first type, and the lower flat sheet 1b and the upper sheet 2a provided with a profile enclose ducts 3b of the second type. The lower flat sheet 1b and the lower sheet 2b provided with a profile further enclose ducts 3a of the first type. Each of the sheets 1, 2 thus lies adjacent on either side to ducts of different type. As already noted, ducts 3 each have substantially the cross-section of an equilateral triangle.

The schematic view shown in FIG. 2 of a sheet 4 provided with a profile shows the multiple trapezium profile of sheet 4. The profile comprises inclining side walls 5a, 5b, upper walls 6 and lower walls 7, wherein the upper and lower walls 6, 7 extend in the main direction of sheet 4 and the inclining side walls 5 extend at an acute angle to the upper and lower walls 6, 7. Ducts 8 with a trapezium-shaped section are hereby formed, which are open on their underside or their upper side and thus have to be closed by another sheet. As a result of this acute angle the upper and lower walls 6, 7 are wide, which provides the option of stacking the thus formed sheets 4 without interposing flat sheets as in the prior art. The flow resistance of ducts 8 with a trapezium-shaped section has further been found to be considerably lower than that of the prior art triangular ducts 3.

As already elucidated above, use is usually made of thermoforming for the purpose of arranging the profile in the sheets. A sheet is placed here on a mould provided with the desired profile, the sheet is heated and the sheet is urged against the mould by means of a difference in air pressure, so that the sheet deformable by means of heating takes on the shape of the mould. After shaping of the sheet it is allowed to cool, after which it retains its shape. The current trapezium shape makes it difficult to remove the formed sheet from the mould, since the combination is not self-releasing. In order to nevertheless be able to remove the sheet from the mould, the upper wall of the sheet is provided with a fold. Such a sheet provided with a fold is shown in FIG. 3. Upper wall 6 is divided into two equal parts 6a and 6b by fold 9. During removal of the sheet from the mould the upper wall can fold at the fold so that the part protruding into the cavity of the mould can be made narrower and can be removed from the mould.

In the embodiment shown in FIG. 3 lower wall 7 is also provided with a fold 10 which divides lower wall 7 into two equal parts 7a and 7b. This fold has no function in the removal of the formed sheet from the mould, but fold 10 does have a function during stacking, as will be elucidated below.

It is possible to stack the thus formed sheet 4 in two different ways. The first stacking method is shown in FIG. 4. The upper walls of the ducts of sheets lying immediately above each other are located here straight above one another. The result thereof is that assembled ducts are obtained with a height double that of the ducts in a single sheet. A significant advantage of this embodiment is that lower wall 7 of upper-lying sheet 4 rests on the single upper wall 6 of underlying sheet 4, wherein both sheets are provided with a fold which makes the relevant walls fit into each other, whereby the sheets are mutually fixed. It is noted here that folds 9, 10 in lower and upper walls 6, 7 do have to point in the same direction in order to achieve this effect. The relatively great height of the assembled duct 3 only has the effect that thermal energy is exchanged via the side walls. Since the upper and lower walls 6, 7 are quite narrow, this is only a small drawback. It is noted that in the shown embodiment the sheets have a profile in the form of an acute-angled trapezium, which has the result that the section of the combined duct is constricted. Not precluded however is that the profile of the sheets is obtuse-angled and the assembled duct widens in the centre. When the assembled profile narrows in the centre it is then recommended that the width of the duct is about 80% of the maximum width of the duct.

This latter stated drawback is however avoided when the sheets are stacked with the lower wall of the ducts of an upper-lying sheet above the upper wall of the ducts of the underlying sheet as shown in FIG. 5. Lower wall 7 of the upper-lying sheet rests here on two different upper walls 6 of the underlying sheet. A part of the half 7a of lower wall 7 more particularly rests on a part of the half 6b of upper wall 6 of the underlying sheet, and a part of the other half 7b of the same lower wall 7 lies on a part of the half 6a of another upper wall 6 of the underlying sheet. Some of the number of ducts 3 are hounded here on their upper side by those parts of lower wall 7 of upper-lying sheet 4 which are not supported by an upper wall 6 of the sheet in which duct 3 extends. Other ducts 3 are bounded on their underside by those parts of upper wall 6 of underlying sheet 4 which do not function as support for the lower wall of sheet 4 in which ducts 3 extend. Another difference from the stacking shown in FIG. 3 is the fact that the folds 9, 10 in the lower and upper surfaces 6, 7 are directed outward in order to obtain the required stability of the stacking; in the stacking method shown in FIG. 3 the fold 10 in lower surface 7 is directed inward and the fold 9 in upper surface 6 is directed outward.

FIG. 6 shows a cross-section of a profile of a sheet 4 as currently envisaged; this relates particularly to the ratio between height and width of duct 3. The ratio of the average height and the average width of the profile is 4.25, although it is likewise possible to apply other ratios in the range between 4 and 5 or between 3 and 6. The ratio of the widest part of the duct and the narrowest part amounts to about 1.2, although it is likewise possible to make use of other ratios between 1.1 and 1.4 or between 1.05 and 1.5.

FIG. 7 shows a cross-section of a mould 20 applied for the purpose of arranging the profile in the sheets. The mould is provided for this purpose with a number of grooves 21, the profile of which corresponds to the profile of the ducts to be formed in the sheet. The grooves are provided with side walls 22 tapering to the outside and with an end wall 24 divided into two parts 24a, 24b by a fold 23. Formed between grooves 21 are intermediate surfaces 25 which are divided into two parts 25a. 25b by a fold 26. Although this is not essential per se, the grooves and intermediate surfaces preferably take a symmetrical form.

FIG. 8 shows a cross-section of mould 20 in combination with a counter-mould 30. Counter-mould 30 is provided with elongate protrusions 31 which can move into grooves 21 of mould 20. Protrusions 31 are provided with two outward tapering side walls 32 ending in a head part provided with four end surfaces 33a, 33b, 33c and 33d. Also arranged in intermediate surfaces 34 between protrusions 31 is a fold 35 which divides intermediate surfaces 34 into two equal parts 34a and 34b. Because side walls 32 of protrusions 31 and side walls 22 of grooves 21 taper in opposite direction, space which is used during the thermoforming is created between grooves 21 and protrusions 31 when protrusions 31 are moved into grooves 21.

As already elucidated, use is made during thermoforming of a medium such as air. For feed and discharge of air use is made of air ducts arranged in mould 20 or in counter-mould 30. In the mould a main air duct 28 extending transversely of the main plane of the mould and of the sheet to be formed is arranged in each of the parts 27 between grooves 21, which air duct is provided with a number of side air ducts 29 debouching in side walls 22 of grooves 21. In counter-mould 30 a main air duct 36 extending transversely of the main plane of the mould is arranged in each of the protrusions, from which air duct branch off a number of side air ducts 37 which debouch in side walls 32. The main air ducts 28, 36 are each connected to a pump not shown in the drawing.

The operation of the thermoforming device comprising mould 20 and counter-mould 30 will now be elucidated. Mould 20 and counter-mould 30 are initially moved apart and the sheet 4 to be deformed is placed between mould 20 and counter-mould 30. Sheet 4 is heated prior to placing, although it is likewise possible for sheet 4 to be heated between mould 20 and counter-mould 30. Preferably heated air is then carried against sheet 4 from the side air ducts 37 arranged in counter-mould 30. Sheet 4 is hereby heated further and the sheet is pressed against mould 20, wherein sheet 4 is made deformable owing to its high temperature and takes on the shape of mould 20. This process is enhanced by the movement of counter-mould 30 toward mould 20, whereby protrusions 31 of counter-mould 30 urge sheet 4 further into grooves 21. This process is continued until protrusions 31 of counter-mould 30 extend wholly into grooves 21 and the air exiting side air ducts 37 urges sheet 4 against walls 22, 23 of grooves 21 and sheet 4 obtains the desired shape.

In order to fix the shape of sheet 4 the whole assembly of mould 20, sheet 4 and counter-mould 30 is cooled by per se known thermal ducts (not shown in the drawing) which are present in mould 20 and counter-mould 30 and with which the mould and the counter-mould can also be heated.

Once the cooling process has been completed, counter-mould 30 is once again moved away from mould 20 and air is blown from side air ducts 29 into mould 20, which air presses toward each other the side walls 5 formed during the process of forming ducts 3 in sheets 4 so that the shaped sheet 4 can be removed. Fold 9 in upper wall 6 of ducts 3 here facilitates movement toward each other of side walls 5 of ducts 3.

FIGS. 9 and 10 show the angle of protrusion 31 of counter-mould 30, i.e. the four-part end wall 33a, 33b. 33c and 33d thereof, in combination with a part of the deforming sheet 4 during the above elucidated process. FIG. 9 shows here the situation in which protrusion 31 presses fold 9 of upper wall 6 into fold 23 of end wall 24 of groove 21. It can be seen how the two end surfaces 33b, 33c are in contact with the upper wall 6 of the profile formed from sheet 4. In the situation shown in FIG. 10 protrusion 31 of counter-mould 30 retracts from groove 21. Side walls 5 of duct 3 are urged here against protrusion 31 by the operation of side air ducts 29 in mould 20, whereby upper wall 6 folds more sharply than in the situation shown in FIG. 9, so that side walls 5 together with folded end wall 6 can be moved easily out of groove 21.

1. A heat exchanger, comprising a number of sheets stacked onto each other and extending mutually parallel,
wherein at least some of the number of sheets are provided over at least a part of their surface with profiles which form ducts extending between the sheets and wherein the ducts present on either side of a sheet extend parallel;
wherein each of the sheets lies adjacent on one of its sides to ducts of the first type and lies adjacent on its other side to ducts of the second type;
wherein adjoining sheets stacked onto each other are mutually connected at their edges extending parallel to the ducts;
wherein all sheets are provided with a profile and the profile of each sheet extends over the whole surface of the heat exchanger;
wherein the average height of the ducts is greater than their average width, and
further wherein the sheets are stacked with the lower wall of the ducts of an upper-lying sheet above the upper wall of the ducts of the underlying sheet.

2. The heat exchanger as claimed in claim 1, wherein the profile arranged in the sheets and forming the ducts has the form of multiple trapeziums.

3. The heat exchanger as claimed in claim 2, wherein the ducts have a fold on at least one of their walls extending parallel to the main plane of the sheet.

4. The heat exchanger as claimed in claim 3, wherein the ducts have a fold on both their walls extending parallel to the main plane of the sheet.

5. The heat exchanger as claimed in claim 4, wherein the angles between the walls of the ducts forming part of a single sheet are acute.

6. The heat exchanger as claimed in claim 5, wherein the assembled ducts which are enclosed by two connecting sheets have a constriction in their centre, and that the constriction of the ducts is smaller than 20% of the maximum width of the duct.

7. The heat exchanger as claimed in claim 1, wherein
the sheets extend outside the heat exchanger on a first side of the heat exchanger with a component transversely of the longitudinal direction of the ducts and a second side of the heat exchanger lying opposite the first side,
the parts of the sheets extending on respectively the first and second side of the heat exchanger form respectively a first and second coupling piece;
the first coupling piece is configured to couple a first external duct to a first end of the ducts of the first type and to couple a second external duct to a first end of the ducts of the second type, and
the second coupling piece is configured to couple a third external duct to the second end of the ducts of the first type and to couple a fourth external duct to the second end of the ducts of the second type.

8. The heat exchanger as claimed in claim 1, wherein the sheets are manufactured from plastic sheets deformable by means of a thermoforming process.

9. A method for manufacturing a heat exchanger, comprising of arranging a profile in plastic sheets by means of a thermoforming process, stacking the sheets and mutually connecting the stacked sheets at least at their edges, wherein the sheets are stacked onto each other without interposing flat sheets.

10. The method as claimed in claim 9, wherein the sheets are stacked with the lower wall of the ducts of an upper-lying sheet above the upper wall of the ducts of the underlying sheet.

11. The method as claimed in claim 9, wherein the sheet parts, which after the thermoforming and stiffening through cooling are enclosed due to form-locking in a mould used in the thermoforming process, are deformed during removal of the sheets from these moulds.

12. The method as claimed in claim 9, wherein the sheet parts enclosed in the mould by form-locking are deformed by blowing in air from openings arranged in the mould.

13. The method as claimed in claim 9, wherein the sheets are also deformed during the thermoforming process by a counter-mould provided with protrusions which, in the position in which the sheets have reached their final form, extend into cavities arranged in the mould.

14. The method as claimed in claim 13, wherein air is blown in during the thermoforming process from openings arranged in the counter-mould.

15. A device for manufacturing sheets for a heat exchanger by means of a thermoforming process, wherein the device comprises:
a mould, the profile of which corresponds to the profile to be arranged in the sheets;
means for respectively heating and cooling the sheets;
supply and discharge means for respectively supplying and discharging the sheets to and from the mould; and
pressure means for temporarily applying to the side of the sheet facing away from the mould an air pressure which is higher than the air pressure prevailing on the side of the sheet facing toward the mould,
wherein the device comprises a counter-mould provided with protrusions which extend during the thermoforming process into cavities arranged in the mould.

16. The device as claimed in claim 15, wherein in the mould in the position of the counter-mould lying closest to the mould, the protrusions of the counter-mould extend into the deepest point of the cavities.

17. The device as claimed in claim 15, wherein in the position of the counter-mould lying closest to the mould, the mould and the counter-mould enclose the sheet outside the cavities of the mould.

18. The device as claimed in claim 15, wherein the air pressure means are configured to temporarily apply to the side of the sheet facing away from the mould an air pressure which is lower than the air pressure prevailing on the side of the sheet facing toward the mould.

19. The device as claimed in claim 15, wherein the air pressure means are provided with air ducts ending in the cavities of the mould and connected to an air pump, and with air ducts ending in the cavities of the counter-mould and connected to an air pump.

20. The device as claimed in claim 19, wherein in the position of the counter-mould lying closest to the mould, space is present laterally of the protrusions of the counter-mould between these protrusions and the cavities of the mould.
